(19) United States
(12) Patent Application Publication
(10) Pub. No.: US 2012/0024889 A1
(43) Pub. Date: Feb. 2, 2012

(54) Polypharmacy Co-Packaged Medication Dosing Unit Including Communication System Therefor

(76) Inventors: Timothy Robertson, Belmont, CA (US); Gregory Moon, Palo Alto, CA (US); Benedict Costello, Berkeley, CA (US); Mark Zdeblick, Portola Valley, CA (US); Hooman Hafezi, Redwood City, CA (US)

(21) Appl. No.: 13/180,538

(22) Filed: Jul. 11, 2011

Related U.S. Application Data
(63) Continuation-in-part of application No. 12/564,017, filed on Sep. 21, 2009, now Pat. No. 7,978,064.
Application No. 12/564,017 is a continuation-in-part of application No. 11/912,475, filed on Jun. 23, 2008.
(60) Provisional application No. 60/676,145, filed on Apr. 28, 2005.
(60) Provisional application No. 60/694,078, filed on Jun. 24, 2005.
(60) Provisional application No. 60/713,680, filed on Sep. 1, 2005.
(60) Provisional application No. 60/790,335, filed on Apr. 7, 2006.

(51) Int. Cl. B67D 7/06; B23P 11/00

(52) U.S. Cl. 222/23; 222/192; 29/428

(57) ABSTRACT

A custom medication dosing unit is disclosed. The custom medication dosing unit includes a housing having a shell element provided with a bottom surface and a circumferential edge extending from the bottom surface and a portion defining an opening for accommodating a medication. A first closure element provided with a circumferential edge is placed on the circumferential edge of the shell element in an adhering and closing manner. A medication is disposed within the opening defined between the shell element and the first closure element. A circuit module is associated within the first closure element. A system includes the custom medication dosing unit operative to communicate with a local node. Also disclosed is a method of manufacturing the custom medication dosing unit.

### CROSS-REFERENCE TO RELATED APPLICATIONS

This application is a continuation-in-part of U.S. patent application Ser. No. 12/564,017, filed on Sep. 21, 2009 and entitled “Communication System with Partial Power Source”, published on Apr. 1, 2010 as U.S. Publication No. US2010-0081894A1, which is a continuation-in-part application of U.S. patent application Ser. No. 11/912,475 filed Jun. 23, 2008 and entitled “Pharma-Informatics System”, published on Nov. 20, 2008 as U.S. Publication No. 2008-0284599A1 which application is a 371 application of PCT Application No. PCT/US06/16370 filed Apr. 28, 2006 and entitled “Pharma-Informatics System”; which application pursuant to 35 U.S.C. §119 (e), claims priority to the filing dates of: U.S. Provisional Patent Application Ser. No. 60/676,145 filed Apr. 28, 2005 and entitled “Pharma-Informatics System”; U.S. Provisional Patent Application Ser. No. 60/694,078, filed Jun. 24, 2005, and entitled “Pharma-Informatics System”; U.S. Provisional Patent Application Ser. No. 60/713,680 filed Sep. 1, 2005 and entitled “Medical Diagnostic And Treatment Platform Using Near-Field Wireless Communication Of Information Within A Patient's Body”; and U.S. Provisional Patent Application Ser. No. 60/790,335 filed Apr. 7, 2006 and entitled “Pharma-Informatics System”; the disclosures of which are herein incorporated by reference.

This application is related to the following US Applications filed concurrently herewith, the disclosures of which are incorporated herein by reference: U.S. application Ser. No. ______ COMMUNICATION SYSTEM WITH REMOTE ACTIVATION (Attorney Docket No. PRTS-010CON2CIP (PRO-147)); U.S. application Ser. No. ______ COMMUNICATION SYSTEM WITH MULTIPLE TYPES OF POWER (Attorney Docket No. PRTS-010CON2CIP2 (PRO-148)); U.S. application Ser. No. ______ COMMUNICATION SYSTEM USING AN IMPLANTABLE DEVICE (Attorney Docket No. PRTS-010CON2CIP3 (PRO-149)); U.S. application Ser. No. ______ COMMUNICATION SYSTEM WITH ENHANCED PARTIAL POWER AND METHOD OF MANUFACTURING SAME (Attorney Docket No. PRTS-010CON2CIP4 (PRO-150)); and U.S. application Ser. No. ______ COMMUNICATION SYSTEM INCORPORATED IN AN INGESTIBLE PRODUCT (Attorney Docket No. PRTS-010CON2CIP6 (PRO-152)).

### INTRODUCTION

Patients concurrently taking multiple medications, including prescription and non-prescription drugs, are at greatest risk of polypharmacy consequences. Although polypharmacy may be widespread throughout the general population, it is most common in people with multiple medical conditions. Such patients include the elderly, psychiatric patients, patients multiple drugs concurrently, those with multiple physicians and pharmacies, recently hospitalized patients, individuals with concurrent comorbidities, and those with impaired vision or dexterity, to mention a few.

Polypharmacy generally refers to the use of multiple medications by a patient under various circumstances. Sometimes patients use too many forms of medication. Other times, more drugs are prescribed than is clinically warranted. And sometimes, even when all prescribed medications are clinically indicated, there may be too many pills to take for the patient to take. Polypharmacy generally results in increased adverse drug reactions, drug-drug interactions, and higher costs, among other deleterious effects caused by polypharmacy.

To address various issues associated with polypharmacy, there is a need to custom-package individual medication dosing units for patients that take multiple medications or a regular basis. There also is a need to track the custom-package individual medication dosing units from the pharmacy to the patient and record the time when the package is opened and the medication dosing event occurs.

### SUMMARY

In one aspect, a custom medication dosing unit is provided. The custom medication dosing unit comprises a housing comprising at least one shell element provided with a generally bottom surface and a circumferential edge extending upwardly from the bottom surface and a portion defining an opening for accommodating at least one medication. A first closure element is provided with a circumferential edge placed on the circumferential edge of the shell element in an adhering and closing manner. At least one medication may be disposed within the opening defined between the portion of the shell element and the first closure element. A circuit module is associated within the first closure element.

### FIGURES

FIG. 1 illustrates one aspect of a system for tracking a polypharmacy custom medication dosing unit and recording a medication event associated therewith.

FIG. 2 illustrates one aspect of a system for tracking a polypharmacy custom medication dosing unit and recording a medication event associated therewith.

FIG. 3 illustrates one aspect of a system for packaging and tracking a polypharmacy custom medication dosing unit.

FIG. 4A illustrates one aspect of a single dosing unit customized for an individual patient where the single dosing unit package comprises multiple medications.

FIG. 4B is a partial cutaway view of the multiple medication single dosing unit package shown in FIG. 4A illustrating a circuit element associated in the closure portion of the housing of the multiple medication single dosing unit package.

FIG. 5A is a diagram illustrating a typical packet of information communicated from an individual patient customized single-dose package.

FIG. 5B is a diagram illustrating a typical packet of information communicated from an individual patient customized multi-dose package.

FIG. 6 shows one aspect of a patch.

FIG. 7 shows one aspect of an ingestible event marker.

FIG. 8 illustrates one aspect of a circuit module.

### DESCRIPTION

In various aspects, the present disclosure is directed generally to an apparatus, system, and method for a patient to collaborate with physicians, pharmacies, and/or drug manufacturers to address issues associated with polypharmacy problems. The apparatus, system, and method provide techniques that facilitate increased interaction between the patient and physicians, pharmacies, and/or drug manufacturers to improve medication dosing, reduce cost, and likely reduce the potentially deleterious consequences of polypharmacy. Accordingly, the present disclosure provides various techniques for patients and doctors informing pharmacists of other medications consumed by the patient. It will be appreciated that the term “medication” as used throughout this disclosure includes various forms of ingestible, inhalable, injectable, absorbable, insertable, infusible, or otherwise consumable medicaments and/or carriers therefor such as, for example, pills, capsules, gel caps, placebos, over capsulation carriers or vehicles, herbal, over-the-counter (OTC) substances, supplements, prescription-only medication, ingestible devices (e.g., ingestible event markers (IEM), ingestible radio frequency identification (RFID) devices, ingestible inductive coils, ingestible magnets), and the like.

Generally, in one aspect, the present disclosure provides a personal single or multiple dosing session packages containing multiple medications, which may be prescription or non-prescription medications, co-packaged for a single dosing event. In general terms, a single dosing event may include prescription and non-prescription pharmaceuticals, steroids, vitamins, supplements, pharmaceuticals for co-morbidities (e.g., to address the presence of one or more disorders or diseases in addition to a primary disease or disorder, or the effect of such additional disorders or diseases), ingestible devices (e.g., IEM devices, indicator IEM devices, ingestible RFID tags, ingestible inductive coils, ingestible magnets), to mention a few.

A single dosing package may contain a daily medication dosing session or separate morning (am), afternoon (pm), and/or evening medication dosing sessions. In one aspect, the single dosing pre-packaged unit is like a custom blister pack and contains all the medications for a single dosing event contained in a single individual packaged unit.

A multiple dosing package may contain a multiple daily medication dosing sessions such as morning (am), afternoon (pm), and/or evening medication dosing sessions or weekly medication dosing sessions in individualized compartments or prepackaged units. In one aspect, the multiple dosing package is like a custom weekly or monthly medication organizer dispenser tray and contains all the medications for a particular period such as day, week, month, where each individual dosing session is pre-packaged individually for the entire period.

Each dosing session contained in a single dose or multiple dose pre-packaged unit, whether morning, afternoon, evening, daily, weekly, monthly, and so on, may be custom packaged for an individual patient and may be marked with the name of the patient, the date the pre-packaged unit was packaged, the dosing event (e.g., morning, evening, daily, weekly—M, T, W, Th, F, Sa, Su, and so on), and the contents, for example. In some aspects, the expiration date or shelf life of the medication also may be indicated on the pre-packaged unit. In other aspects, an ingestible device may be contained in the single dose or multiple dose pre-packaged unit and the type of ingestible device (e.g., IEM devices) may be indicated on the pre-packaged unit.

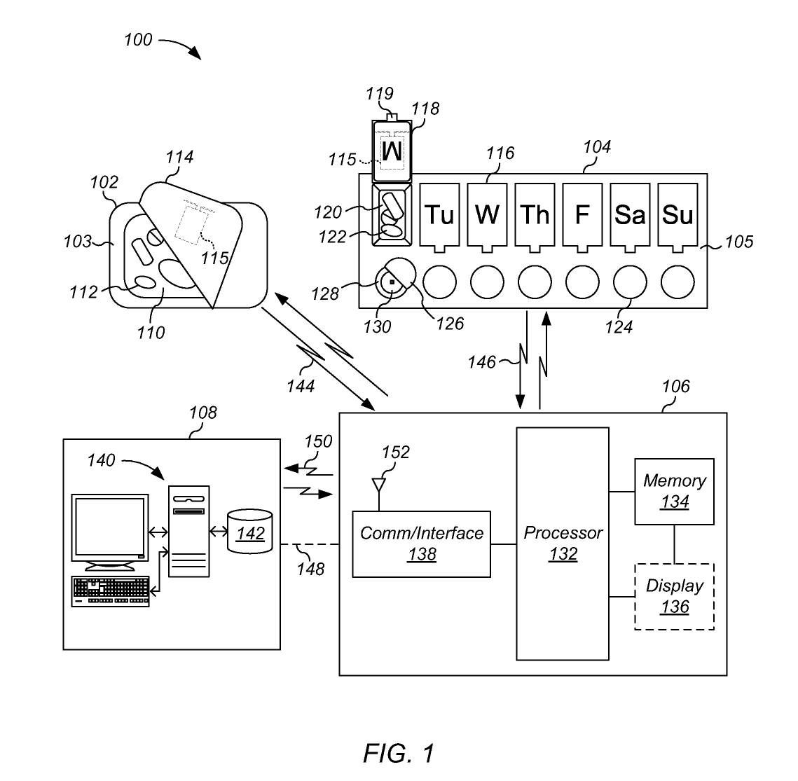

For clarity of disclosure, these and other aspects of the present disclosure will now be described in conjunction with the associated figures. Accordingly, turning now to FIG. 1, one aspect of a system 100 for tracking a polypharmacy custom medication dosing unit provided in package 102, 104 and recording a medication dosing event associated therewith is illustrated. In one aspect, a single-dose package 102 contains a single dosing unit comprising one or more medications 112. In one aspect, the single dosing unit also may comprise a medication device. In various other aspects, the medication device may comprise any suitable form of medication as defined above (e.g., ingestible, inhalable, injectable, absorbable, insertable, infusible, or otherwise consumable medicaments and/or carriers therefor such as, for example, pills, capsules, gel caps, placebos, over capsulation carriers or vehicles, herbal, over-the-counter (OTC) substances, supplements, prescription-only medication, ingestible devices such as, IEM devices, ingestible RFID tags, ingestible inductive coils, ingestible magnets, and the like). In one aspect, a multi-dose package 104 comprises a plurality of compartments 116 where each of the compartments 116 contains a single dosing unit comprising one or more medications 122. In one aspect, the single dosing unit in each of the compartment 116 may comprise an ingestible device such as an IEM device, ingestible RFID tag, ingestible inductive coil, ingestible magnet, and the like. In another aspect, the multi-dose package 104 may comprise an additional portion for storing a plurality of IEM devices in separate storage compartments 124. In FIG. 1, the single-dose package 102 is intended for a single medication dose whereas the multi-dose package 104 is intended for multiple medication doses over a period of one week.

In the particular aspect of the system 100 shown in FIG. 1, the single-dose package 102 and the multi-dose package 104 are shown in communication with a local node 106 via respective wireless media 144, 146. The local node 106 is shown in communication with a remote node 108 via communication link 150. Furthermore, the single-dose and multi-dose packages 102, 104 shown in FIG. 1 are provided for illustrative purposes only and other configurations may be substituted that fall within the contemplated aspects of the present disclosure. For example, as shown, it will be appreciated that other communication configurations between the single-dose and multi-dose packages 102, 104, the local node 106, and remote node 108 are contemplated to be within the scope of the present disclosure and accordingly, the appended claims should not be limited in this context.

In one general aspect, when a peel-off closure element 114 is removed from the single-dose package 102 a circuit module is activated and generates a signal, which is transmitted to the local node 106. Similarly, when a closure element 118 of the multi-dose package 104 is opened, another signal is generated and transmitted to the local node 106. The signal may include any information associated with the single-dose or multi-dose packages 102, 104 or the medication contained therein. The local node 106 may act as a local access point to the Internet and communicates the information received from the single and/or multiple medication dosing unit packages 102, 104 to the remote node 108. The remote node 108 may be a physician's office, pharmacy, drug manufacturer, nutrition center, and the like. These and other aspects of the system will be described in more detail hereinbelow.

As shown in FIG. 1, in one aspect, a custom medication dosing unit may be contained in a single medication dosing unit package 102. The single-dose package 102 may contain one or more medications 112 suitable for a single medication dosing event. In the aspect shown in FIG. 1, the single-dose package 102 comprises multiple medications 112 customized for an individual patient to be consumed in a single dosing event.

In one aspect, the single-dose package 102 may have a small tray-like form factor having a portion 110 (e.g., a central portion) defining an opening to accommodate the medication 112 therein and a peel-off closure element 114. The single-dose package 102 is suitable for containing one or more medications 112 for a single dosing unit. The package comprises a shell element 103 provided with a bottom surface and a circumferential edge extending upwardly from the bottom surface and the portion 110 defining an opening for accommodating the medication(s) 112. In one aspect, the bottom surface is generally planar. In other aspects the bottom surface may take any number of suitable configurations. The single-dose package 102 also comprises a closure element 114 provided with a circumferential edge placed on the circumferential edge of the shell element 103 in an adhering and closing manner. In one aspect, the circumferential edge of the shell element 103 may be substantially upright. In other aspects, the circumferential edge of the shell element 103 may be slanted inwardly or outwardly, among other configurations. The closure element 114 is configured to peel-off the shell element 103 for the purpose of peeling off the closure element 114 from the shell element 103 to expose the central portion 110 to provide access to the medication(s) 112. The closure element 114, shown in a partially opened peeled back position, is adhered on the open side of the shell element 103 of the housing 103 to seal the medication 112 within the package. The closure element 114 protects the medications 112 from the environment and, in various aspects, provides a moisture barrier, light barrier, and security. In another aspect, padding or nesting features may be provided in the interior opening of the shell element 103 to pad or a nest to receive the medication(s) 112 and prevents them from rattling inside the shell element 103. The shell element 103 and the closure element 114 may be formed of a variety of polymers, metals, or combinations thereof, and in one aspect the shell element 103 and the closure element 114 may be formed of aluminum. The closure element 114 may be configured to be opened in a relatively easy operation and in one aspect may be opened in one peeling operation by the user. It will be appreciated that other form factors are contemplated to be within the scope of the present disclosure, but are not shown for clarity of disclosure. For example, dual morning/afternoon (am/pm) medication dosing packages, as well as other custom packages such as a blister pack form factor are within the scope of the present of the disclosure.

In one aspect, the single-dose package 102 can be pre-packaged and customized for an individual patient by a physician, pharmacy, drug manufacturer, nutrition center, or other third party, or combinations thereof. Since the single-dose package 102 contains individualized daily medication doses specifically customized for the patient, it would be helpful to mark the exterior portion of the single-dose package 102 with the contents thereof. Accordingly, in one aspect, such markings may be provided either on the closure element 114 or portions of the shell element 103 (e.g., exterior sidewalls or bottom portions) in order to mark the single-dose package 102 with customized information associated with the individual patient and/or the medication(s) 112. The customized information may include, without limitation, the name of the patient, the packaging date, the dosing event (e.g., morning, evening, daily), and the contents of the package, such as the identity of the medication(s) 112 contained inside the single-dose package 102, for example. In some aspects, the expiration date or shelf life of the one or more medication(s) 112 contained inside the single-dose package 102 may be indicated on the exterior of the single-dose package 102. In other aspects, the type of IEM device contained inside the single-dose package 102 may be indicated on the exterior of the single-dose package 102.

As shown in FIG. 1, in one aspect, the multi-dose package 104 comprises a housing 105 having a plurality of compartments 116 where each of the compartments 116 contains a single dosing unit comprising one or more medications 122. In one aspect, the single dosing unit contained in each of the compartments 116 may comprise an ingestible device. In another aspect, the multi-dose package 104 may comprise an additional portion for storing a plurality of IEM devices 130, for example, in separate storage compartments 124. In FIG. 1, the multi-dose package 104 is intended for multiple medication doses over a period of one week.

In one aspect, each of the compartments 116 have a shell element provided with a bottom surface and a circumferential edge extending upwardly from the bottom surface and a portion 120 defining an opening for accommodating the medication(s) 122 therein. In one aspect, the bottom surface may be substantially planar. In other aspects the bottom surface may take any number of suitable configurations. In one aspect, the circumferential edge of the shell element may be substantially upright. In other aspects, the circumferential edge of the shell element may be slanted inwardly or outwardly, among other configurations. Each of the compartments 116 of the multi-dose package 104 is labeled with the day of the week (e.g., M, Tu, W, Th, F, Sa, Su). Each of the compartments 116 of the multi-dose package 104 also comprises a closure element 118 provided with a circumferential edge and a tab portion 119 for latching the closure element 118 in a closing manner. The closure element 118 is configured to pivot in an open and closed position. As shown in FIG. 1 with respect to the Monday (M) compartment, the closure element 118 is in an open position and the remaining closure elements for Tuesday-Sunday (Tu-Su) are in a closed position. Placing the closure element in the open position provides access to the central portion 120 and the medication(s) 122 contained therein. In the closed position, the tab portion 119 portion of the closure element 118 mates with a corresponding edge of the compartment 116 to latch in a closed position.

In the closed position, the closure element 118 protects the medication(s) 122 contained in the central portion 120 from environmental factors such as moisture and light and provides security. In another aspect, padding or nesting features may be provided in the interior opening of the shell element to pad or a nest to receive the medication(s) 122 and prevent them from rattling inside the compartment 116. The housing 105 including the compartments 116 and the closure elements 118 may be formed of a variety of polymers, metals, or combinations thereof, and in one aspect the housing 105 and the closure elements 114 may be formed of a polymer. The closure elements 114 may be configured to be opened in a relatively easy operation and in one aspect may be opened in a single rotatable operation by the user. It will be appreciated that other form factors are contemplated to be within the scope of the present disclosure, but are not shown for clarity of disclosure. For example, dual morning/afternoon (am/pm) medication dosing packages, as well as other custom packages such as a blister pack form factor are within the scope of the present of the disclosure.

As previously mentioned, in one aspect the, the multi-dose package 104 may comprise a plurality of compartments 124 for storing a plurality of IEM devices 130. As shown, the IEM compartments 124 comprise a well 128 for accommodating an ingestible device, such as a single IEM device 130, as shown, for example. The IEM compartment 124 includes a closure element 126, shown partially opened, to protect the IEM device 130 from environmental factors such as moisture and light and also provides security before usage. In one aspect, the additional IEM compartments 124 are blister packs where the closure elements 126 are formed of a thin aluminum sheet such that the IEM device 130 can be pushed therethrough for access by the patient. Although the multi-dose package 104 is shown in a weekly dosage configuration, other configurations such as semi-daily (am/pm), monthly dosage, are contemplated within the scope of the present disclosure.

In one aspect, the multi-dose unit 104 can be pre-packaged and customized for an individual patient by a physician, pharmacy, drug manufacturer, third party, or combinations thereof. The multi-dose package 104 contains one week's worth of individualized daily medication doses specifically customized for the patient. In one aspect, the closure element 118, or portions of the housing 105 (e.g., sidewalls or bottom portion), may be used to mark the multi-dose unit 104 with customized information associated with the individual patient. The customized information may include, without limitation, the name of the patient, the packaging date, the dosing event (e.g., morning, evening, daily), and the contents of the package, such as the identity of the medication(s) 122 contained inside each of the compartments 116, for example. As shown, the individual compartments 116 of the multi-dose package 104 are marked with the day of the week (e.g., M, Tu, W, Th, F, Sa, Su) in which the patient is to consume the dosing event contained within the central portion 120. In some aspects, the expiration date or shelf life of the one or more medication(s) 122 may be indicated on an exterior portion of the closure element 118, or exterior portions of the housing 105. In other aspects, the type of IEM device 130 contained in the multi-dose package 104 may be indicated on an exterior portion of the closure element 118, or exterior portions of the housing 105.

In one aspect, the single-dose package 102 and the multi-dose package 104 may comprise electronic circuit module 115 integrated therewith, e.g., the housing 103 105 and/or the closure elements 114, 118. The single- and multi-dose packages 102, 104 may include any type of circuit module 115 configured to activate when the closure element 114 has been removed (e.g., by peeling or blistering), transmitting information associated with the single- and/or multi-dose packages 102, 104, and recording a time stamp associated with such event. In various aspects, a sensor element may be provided to detect the when the closure the closure element 114, 118 of the single- or multi-dose packages 102, 104 is removed from the corresponding shell element 103, 116.

In certain aspects, an ingestible device, e.g., the IEM device 130 may be provided in the single- or multi-dose packages 102, 104 as part of the single medication dosing unit. When the IEM device is ingested and activated, the IEM device 130 may communicate with the external node 106 to confirm that the single- or multi-dose package 102, 104 was opened and that the IEM device 130 was ingested by the patient. Examples of an IEM are described in U.S. patent application Ser. No. 12/564,017, supra. In one example of the IEM. It will be appreciated that the IEM device 130 is presumably ingested along with the other medication(s) 112, 122 provided inside the respective single- or multi-dose package 102, 104. Accordingly, the communication indicating that the IEM device 130 was ingested may be employed to confirm at least that the IEM device 130 was ingested and to infer that the other medication(s) 112, 122 also were consumed (e.g., ingested, inhaled, injected, absorbed) by the patient.

In one aspect, an ingestible device, e.g., the IEM device 130, may communicate with the circuit module 115 before being ingested by the patient. This may be triggered by a timer mechanism or by a latching or locking mechanism provided on or in the single- or multi-dose packages 102, 104. In various aspects, this communication technique may be useful to confirm that the patient takes the ingestible device within a predetermined time period after opening the package or triggering an alarm. By way of example and not limitation, in one aspect, the ingestible device, e.g., the IEM device 130, may communicate to the circuit module 115, or the local node 106 directly, that the single- or multi-dose package 102, 104 has been opened. Once the “package open” signal is transmitted, a timer may be initiated. When the patient ingests the ingestible device, the ingestible device communicates to the local node 106 the ingestion event and the timer is reset. If the timer expires, an alarm indication is set. Accordingly, by monitoring the timer status, the local node 106 may provide a confirmation that the patient actually ingested the ingestible device after the single- or multi-dose package 102, 104 was opened. Other suitable techniques may be employed other then timers such as direct communication with the local node after the single- or multi-dose package 102, 104 is opened and after the ingestion event occurs to confirm the ingestion event.

Turning now briefly to FIG. 8, in one aspect, the circuit module 115 may include a radio subsystem 800, a processing subsystem 802, a memory subsystem 804, and/or a power subsystem 806. In one aspect, the circuit module 115 comprises an optional power storage unit 808 (shown in phantom) to receive power from an external source and store the power in the power storage unit 808. The power storage unit 808 may comprise any suitable energy storage element such as a capacitor, supercapacitor, rechargeable battery cell (or multiple rechargeable battery cells), among other energy storage elements. In various aspects, the energy storage element of the power storage unit 808 may be charged via direct coupling, inductive coupling, electromagnetic coupling, eddy current, solar power, among other suitable energy coupling techniques. In one aspect, an inductive charging device, such as an inductive charging pad, may provide a wireless charging technique similar to that used for mid-sized items such as cell phones, MP3 players, personal; digital assistants (PDAs), tablet computers, and the like. In inductive charging, an adapter equipped with contact points may be attached to a back plate coupled to the power storage unit. When the power storage unit 808 requires a charge, it may be placed on a conductive charging pad. Once the contact points come in contact with the conductive surface of the charging pad, a small current moves through coils located in the charging pad, creating a small magnetic field which is gathered by the contact points of the adapter and converted into energy. The energy gathered is transferred to the rechargeable battery (capacitor or supercapacitor) of the power storage unit 808, as efficiently as if the device were connected to a wall socket with its regular wired adapter, for example.

Turning back now to FIG. 1, in one aspect, the electronic circuit module 115 integrated with the single- or multi-dose package 102, 104 may include a basic radio circuit including a transmitter, receiver, and/or transceiver to communicate information associated with the single- or multi-dose package 102, 104, such as opening the packages, purchasing, storing, and/or ingesting the IEM device 130. In certain aspects, the circuit module 115 may include other elements such as digital memory and a processor coupled thereto. The radio portion of the circuit module 115 is configured to communicate with the local node 106 and/or other nearby single- or multi-dose packages located in proximity to the single- or multi-dose package 102, 104 over the wireless media 144, 146. In various aspects, the circuit module 115 may be powered by an on-board battery or may be powered by a passive electromagnetic field in a manner similar to the way radio frequency identification (RFID) tags are powered using an external interrogation electromagnetic field without employing an on-board battery. In one aspect, any of the systems such as the patch 214, the mobile device 216, and/or the access point 208 may generate an external interrogation signal to power the circuit module 115.

In various aspects, upon opening the closure element 114, 118, the radio of the circuit module 115 is activated and begins transmitting information to the local node 106 and/or to other single- or multi-dose package(s) 102, 104 over the wireless media 144, 146. The communication capabilities of the single- or multi-dose package 102, 104 provide integrity of supply chain, an interface for physicians such that the physician can select which medication doses (e.g., pills) go into the package, an interface for end users (e.g., patients or personal caregivers) to configure the types of medication doses or co-ingested IEM devices 130 to include in the single- or multi-dose package 102, 104. The information includes any information suitable for identifying the single- or multi-dose package 102, 104, the contents thereof, the source (e.g., physician, pharmacy, drug manufacturer, nutrition center), the end user or consumer (e.g., patient), and the like. The information may be transmitted using any suitable analog and/or digital technique. In various aspects, for example, the single- or multi-dose package 102, 104 may transmit information in the form of a packet, e.g., a formatted unit of data consisting of control information and user data (also known as payload). The control information provides data that the local node 106 needs to deliver the user data to the external node 108 such as source and destination addresses, error detection codes like checksums, and sequencing information. Typically, control information is found in packet headers and trailers, with user data in between. In other aspects, the information may be transmitted in a traditional point-to-point communication link to the local node 106 and may simply transmit data as a series of bytes, characters, or bits alone. In other aspects, the information may be transmitted using analog modulation and transmission techniques.

The information transmitted by the circuit module 115 may comprise a series of digits representing a suitable identification number such as a serial number, for example, of the single- or multi-dose package 102, 104. In addition, the packet may include information associated with the type of package (single, multiple, morning, afternoon, evening, daily, weekly, monthly dosing event, and so on) the individual patient identification, the date of pre-packaging, the source, and the contents of the package, for example. In some aspects, the expiration date or shelf life of one or all of the medication(s) 112, 122 contained in the respective single- or multi-dose packages 102, 104 also may be transmitted by the single- or multi-dose packages 102, 104. The information may be communicated with encryption where a secret key may be provided by an entity associated with a remote node 108 such as a physician, pharmacy, drug manufacturer, nutrition center, for example. The IEM device 130, as discussed in more detail hereinbelow, may be configured to be activated either upon opening the single- or multi-dose package 102, 104 or by ingestion by the patient, for example.

FIG. 1 illustrates one aspect of a local node 106 in communication with the single- or multi-dose package 102, 104 over wireless media 144, 146. In various aspects, the local node 106 may comprise or be implemented by a wireless device. The local node 106 generally may comprise various physical or logical elements implemented as hardware, software, or any combination thereof, as desired for a given set of design parameters or performance constraints. In various aspects, the physical or logical elements may be connected by one or more communications media. For example, communication media may comprise wired communication media, wireless communication media, or a combination of both, as desired for a given implementation.

As shown, the local node 106 may comprise an optional display 136. The display 136 may be implemented using any type of visual interface such as a liquid crystal display (LCD).

As shown, the local node 106 may comprise a memory 134. In various aspects, the memory 134 may comprise any machine-readable or computer-readable media capable of storing data, including both volatile and non-volatile memory. For example, memory may include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

The local node 106 may comprise a processor 132 such as a central processing unit (CPU). In various aspects, the processor 132 may be implemented as a general purpose processor, a chip multiprocessor (CMP), a dedicated processor, an embedded processor, a digital signal processor (DSP), a network processor, a media processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor 510 also may be implemented by a controller, a microcontroller, an application specific integrated circuit (ASIC), a field programmable gate array (FPGA), a programmable logic device (PLD), and so forth.

In various aspects, the processor 132 may be arranged to run an operating system (OS) and various mobile applications. Examples of an OS include, for example, operating systems generally known under the trade name of Microsoft Windows OS, and any other proprietary or open source OS. Examples of mobile applications include, for example, a telephone application, a camera (e.g., digital camera, video camera) application, a browser application, a multimedia player application, a gaming application, a messaging application (e.g., e-mail, short message, multimedia), a viewer application, and so forth.

In various aspects, the processor 132 may be arranged to receive information through a communications interface 138. The communications interface 138 may comprises any suitable hardware, software, or combination of hardware and software that is capable of coupling the local node 106 to one or more networks and/or devices. In one aspect, the local node 106 is in wireless communication with the single-dose package 102 via the wireless medium 144. The local node 106 also may be in wireless communication with the multi-dose package 104 via the wireless communication medium 146. The local node 106 may communicate with the remote node 108 via wired communication medium 148 or wireless communication medium 150. The communications interface 138 may be arranged to operate with any suitable technique for controlling information signals using a desired set of communications protocols, services or operating procedures. The communications interface 138 may include the appropriate physical connectors to connect with a corresponding communications medium, whether wired or wireless.

Vehicles of communication include a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments include in-body communications, various devices, various modes of communications such as wireless communications, wired communications, and combinations of the same.

Wireless communication modes include any mode of communication between points that utilizes, at least in part, wireless technology including various protocols and combinations of protocols associated with wireless transmission, data, and devices. The points include, for example, wireless devices such as wireless headsets, audio and multimedia devices and equipment, such as audio players and multimedia players, telephones, including mobile telephones and cordless telephones, and computers and computer-related devices and components, such as printers.

Wired communication modes include any mode of communication between points that utilizes wired technology including various protocols and combinations of protocols associated with wired transmission, data, and devices. The points include, for example, devices such as audio and multimedia devices and equipment, such as audio players and multimedia players, telephones, including mobile telephones and cordless telephones, and computers and computer-related devices and components, such as printers.

Accordingly, in various aspects, the communications interface 138 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the local node 106 may include a wireless interface comprising one or more antennas, transmitters, receivers, transceivers, amplifiers, filters, control logic, and so forth.

In various aspects, the local node 106 may provide voice and/or data communications functionality in accordance with different types of cellular radiotelephone systems. In various implementations, the described aspects may communicate over wireless shared media in accordance with a number of wireless protocols. Examples of wireless protocols may include various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may include various wireless wide area network (WWAN) protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may include near-field communication techniques and protocols, such as electro-magnetic induction (EMI) techniques. An example of EMI techniques may include passive or active radio-frequency identification (RFID) protocols and devices. Other suitable protocols may include Ultra Wide Band (UWB), Digital Office (DO), Digital Home, Trusted Platform Module (TPM), Zig Bee, and so forth.

In various implementations, the described aspects may comprise part of a cellular communication system. Examples of cellular communication systems may include CDMA cellular radiotelephone communication systems, GSM cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) wireless standards systems such as WCDMA, CDMA-2000, UMTS cellular radiotelephone systems compliant with the Third-Generation Partnership Project (3GPP), fourth generation (4G) wireless standards, and so forth.

In various aspects, the local node 106 includes the functionality to wirelessly receive and/or wirelessly transmit data received from the single- or multi-dose packages 102, 104 and transmit that data to other nodes, such as the external node 108 or other nearby single- or multi-dose packages.

Further, in various aspects, the local node 106 may incorporate and/or be associated with, e.g., communicate with, various devices. Such devices may generate, receive, and/or communicate data, e.g., physiologic data. The devices include, for example, “intelligent” devices such as gaming devices, e.g., electronic slot machines, handheld electronic games, electronic components associated with games and recreational activities.

The local node 106 may be implemented as a mobile telephone. For example, the local node 106 may be implemented as a short-range, portable electronic device used for mobile voice or data communication over a network of specialized cell site base stations. The mobile telephone is sometimes known as or referred to as “mobile,” “wireless,” “cellular phone,” “cell phone,” or “hand phone (HP),” “smart phone.”

In addition to the standard voice function of a telephone, various aspects of mobile telephones may support many additional services and accessories such as short message service (SMS) for text messaging, email, packet switching for access to the Internet, java gaming, wireless, e.g., short range data/voice communications, infrared, camera with video recorder, and multimedia messaging system (MMS) for sending and receiving photos and video. Some aspects of mobile telephones connect to a cellular network of base stations (cell sites), which is, in turn, interconnected to the public switched telephone network (PSTN) or satellite communications in the case of satellite phones. Various aspects of mobile telephones can connect to the Internet, at least a portion of which can be navigated using the mobile telephones.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth.

In one aspect, the local node 106 may be configured as a communication hub and may include any hardware device, software, and/or communications component(s), as well as systems, subsystems, and combinations of the same which generally function to communicate information received from the single-dose package 102 and/or the double-dose package 104 to the remote node 108. Communication of the information includes receiving, storing, manipulating, displaying, processing, and/or transmitting the data to the remote node 108 via wired or wireless media 148, 150.

In various aspects, the local node 106 also functions to communicate, e.g., receive and transmit, non-physiologic data. Example of non-physiologic data include gaming rules and data generated by a separate cardiac-related device such as an implanted pacemaker and communicated to the hub directly or indirectly, e.g., via the personal communicator 104.

Broad categories of local nodes 106 include, for example, base stations, personal communication devices, handheld devices, and mobile telephones. In various aspects, the local node 106 may be implemented as a handheld portable device, computer, mobile telephone, sometimes referred to as a smartphone, tablet personal computer (PC), kiosk, desktop computer, or laptop computer, or any combination thereof. Examples of smartphones include, for example, products generally known under the following trade designations Palm, Blackberry, iPhone, Android, Windows Phone, among others. Although some aspects of the external local node 106 may be described with a mobile or fixed computing device implemented as a smart phone, personal digital assistant, laptop, desktop computer by way of example, it may be appreciated that the various aspects are not limited in this context. For example, a mobile computing device may comprise, or be implemented as, any type of wireless device, mobile station, or portable computing device with a self-contained power source, e.g., battery, such as the laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, pager, messaging device, data communication device, and so forth. A fixed computing device, for example, may be implemented as a desk top computer, workstation, client/server computer, and so forth.

The local node 106 comprises personal communication devices including, for example, devices having communication and computer functionality and typically intended for individual use, e.g., mobile computers, sometimes referred to as “handheld devices.” Base stations comprise any device or appliance capable of receiving data such as physiologic data. Examples include computers, such as desktop computers and laptop computers, and intelligent devices/appliances. Intelligent devices/appliances include consumer and home devices and appliances that are capable of receipt of data such as physiologic data. Intelligent devices/appliances may also perform other data-related functions, e.g., transmit, display, store, and/or process data. Examples of intelligent devices/appliances include refrigerators, weight scales, toilets, televisions, door frame activity monitors, bedside monitors, bed scales. Such devices and appliances may include additional functionality such as sensing or monitoring various physiologic data, e.g., weight, heart rate. Mobile telephones include telephonic communication devices associated with various mobile technologies, e.g., cellular networks.

Still with reference to FIG. 1, the local node 106 is in communication with the remote node 108. The remote node 108 comprises a processing system 140 communicatively coupled to a database 142. Information associated with all patients, including identity and medication types and doses, may be stored in the database 142. The processing system 140 receives information from the local node 106 and accesses the information in the database 142 of the remote node 108 to provide information to the care provider through the local node 106. The remote node 108 can communicate information including a photo of the patient for identification, the type of medication available to the care provider, as well as confirmation of the type and dose of medication that the care provider selects and delivers to the patient. The local node 106 can communicate with the remote node 108 using any mode and frequency of communication that is available in at the site, such as wireless, G2, G3, G4, real-time, periodically based on predetermined time delays, as well as store and forward at later time.

Vehicles of communication between the local node 106 and the remote node 108 include a network. In various aspects, the network comprises local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments include in-body communications, various devices, various modes of communications such as wireless communications, wired communications, and combinations of the same.

The processing system 140 at the remote node 108 may comprise servers configured as desired, e.g., to provide for subject directed permissions. For example, the servers may be configured to allow a family caregiver to participate in the subject's therapeutic regimen, e.g., via an interface (such as a web interface) that allows the family caregiver to monitor alerts and trends generated by the server, and provide support back to the patient. The servers also may be configured to provide responses directly to the subject, e.g., in the form of subject alerts, subject incentives, which are relayed to the subject via the communication device. The servers also may interact with a health care professional, e.g., RN, physician, which can use data processing algorithms to obtain measures of health and compliance of the subject, e.g., wellness index summaries, alerts, cross-patient benchmarks, and provide informed clinical communication and support back to the patient. The servers also may interact with pharmacies, nutrition centers, and drug manufactures.

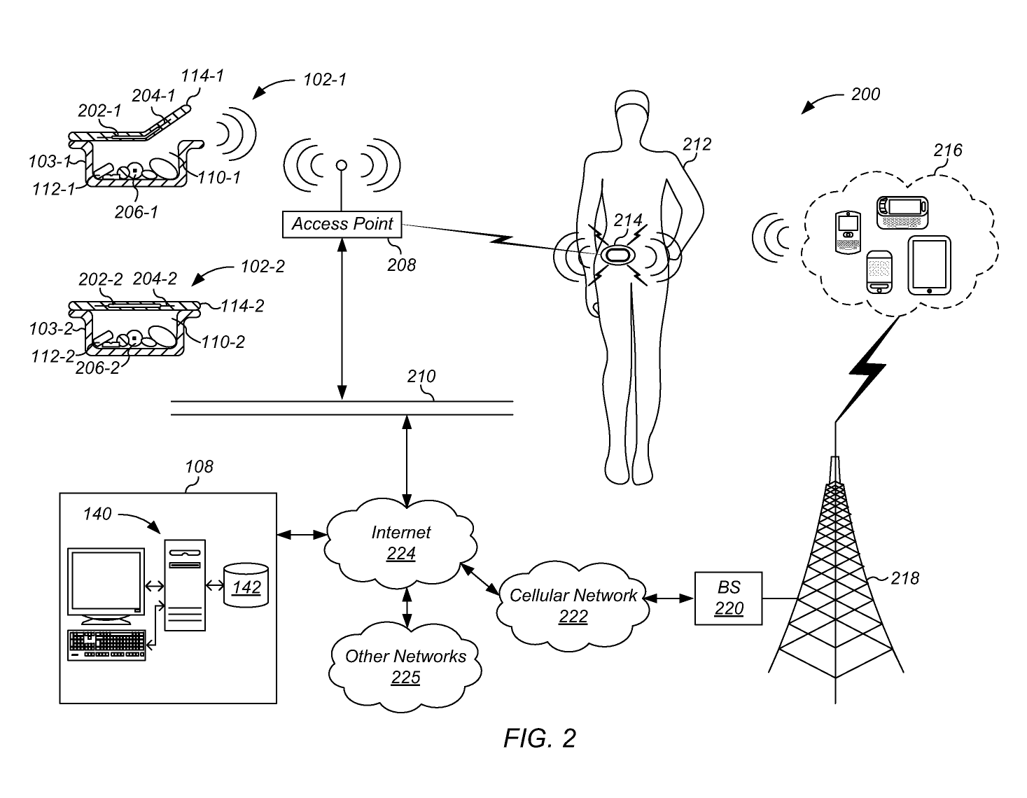

In one aspect, the remote node 108 may store in the database 142 the time and date stamp when the single- or double-dose 102, 104 packages are opened. In addition, when an IEM device 130 is provided in the dosing unit, the time and date stamp of when the IEM device 130 was ingested by the patient also may be stored in the database 142. In addition, an identification number such as a serial number, for example, identifying the single- or multi-dose packages 102, 104, the type of package (single, multiple, morning, afternoon, evening, daily, weekly, monthly dosing event, and so on) the individual patient identification, the date of pre-packaging, the source, and the contents of the package, for example, may be stored in the database 142. In some aspects, the expiration date or shelf life of one or all of the medication(s) 112, 122 contained in the respective single- or multi-dose packages 102, 104 also may be stored in the database 142. A specific implementation of the system 100 for tracking a polypharmacy custom medication dosing unit is described hereinbelow in connection with FIG. 2.

FIG. 2 illustrates one aspect of a system 200 for tracking a polypharmacy custom medication dosing unit and recording a medication event associated therewith. For illustrative purposes, the system shows cross-sectional views of a single-dose package 102 in an open configuration 102-1 and a closed configuration 102-2. The single-dose package 102 comprises one or more medications 112 and in some aspects one or more IEM devices 206. The single-dose package 102 comprises a shell element 103 and a closure element 114. A circuit element 202 comprising an antenna 204 is associated (e.g., embedded) in the closure element 114. When the closure element 114 is in a closed configuration, the circuit element 202 is not activated. Although only the single-dose package 102 is disclosed in FIG. 2 for clarity of disclosure, the same principles apply to the multi-dose package 104 described with reference to FIG. 1. Accordingly, the particular aspects of the polypharmacy custom medication dosing unit packages are not limited in the context of the aspects described with reference to FIG. 2.

When the closure element 114 is peeled off, as shown by the single-dose package 102-1, the circuit element 202 is activated and initiates a wireless transmission using the antenna 204 of the information associated with the single-dose package 102-1. As previously discussed in connection with the description associated with FIG. 1, the information comprises the single-dose package 102-1 identification number, patient identification information (e.g., name, address, phone number, email, social network web address), dosing unit 112 identification, IEM device 206 identification, time and date stamp when the single-dose package 102-1 was opened, time and date stamp when the IEM device was ingested by the patient and activated, among other information.

In one aspect, the opened single-dose package 102-1 communicates with a local wireless access point 208 (e.g., Wi-Fi), which is coupled to a local area network 210 (LAN). The LAN 210 is coupled to a wide area network such as Internet 224, which is coupled to the remote node 108. Accordingly, upon opening the closure element 114 the single-dose package 102-1 is able to communicate information to the remote node 108 via the access point 208, the LAN 210 to hop on the Internet 224, and to the processing system 140 at the remote node 108 receives the information and stores it for processing by the database 142. The remote node 108 can access other networks 225 for processing the information received from the single-dose package 102-2.

In another aspect, the opened single-dose package 102-1 communicates with a one or more mobile devices 216. The mobile devices 216 may be a handheld portable device, mobile telephone, smartphone, tablet personal computer (PC), or any combination thereof, configured to communicate over a wireless cellular network. The mobile device 216 receives the transmission from the opened single-dose package 102-1. The mobile device 216 communicates with a cell tower 218 and base station 220 and can access the Internet 224 via the cellular network 222. Accordingly, information received from the opened single-dose package 102-2 can be communicated to the remote node 108 via the Internet 224. The processing system 140 at the remote node 108 receives the information and stores it for processing by the database 142.

In another aspect, when the patient 212 opens the single-dose package 102-1 and ingests an IEM device 206, the IEM device 206 communicates with a patch 214 which includes various electronic modules for receiving a unique signature from the ingested IEM device 206 and communicating with local nodes. It will be appreciated, that in various aspects, the patch 214 may be configured to communicate with the access point 208 as well as the mobile device(s) 216. It will also be appreciated that the IEM device 206 can communicate with any system, such as the access point 208 or the mobile device 216 prior to ingestion as well as while in the package. Thus the patch 214 can effectively communicate with the remote node 108 via the Internet 224 through the LAN 210 or the cellular network 222. Substantially concurrently with the ingestion of the IEM device 206, the opened single-dose package 102-1 also initiates communications with either the access point 208 or the mobile device(s) 216 to communicate the information associated with the single-dose package 102-1 to the remote node 108. Software application algorithms resident at any node along the communication path, e.g., another single- or multi-dose package 102-1, the access point 208, the patch 214, the mobile device(s) 216, a server at the base station 220, a server at the cellular network 222, the processing system 140, can correlate the event of ingestion of the IEM device 206 with the patient consuming the other medication(s) 112 contained in the single-dose package 102-1.

In other aspects, the opened single-dose package 102-1 communicates with a one or more nearby opened or unopened single- or multi-dose packages 102-2. Thus each package can essentially function as a wireless node or relay station. In one aspect, when one package 102-1 is opened to take a first dose of medication(s) 112-1, a signal may be transmitted to another package 102-2 which contains a second dose of medication(s) 112-2 to be consumed by the patient a predetermined later time of the day. For example, when the patient opens the morning (am) single-dose package 102-1 to take the morning dose of medication(s) 112-1, a signal may be transmitted to the an afternoon single-dose package 102-2 to send a reminder in case the patient 212 to take the afternoon medication(s) 112-2. The signal may be detected by any local nodes such as the access point 208, the patch 214, or the mobile device(s) 216.

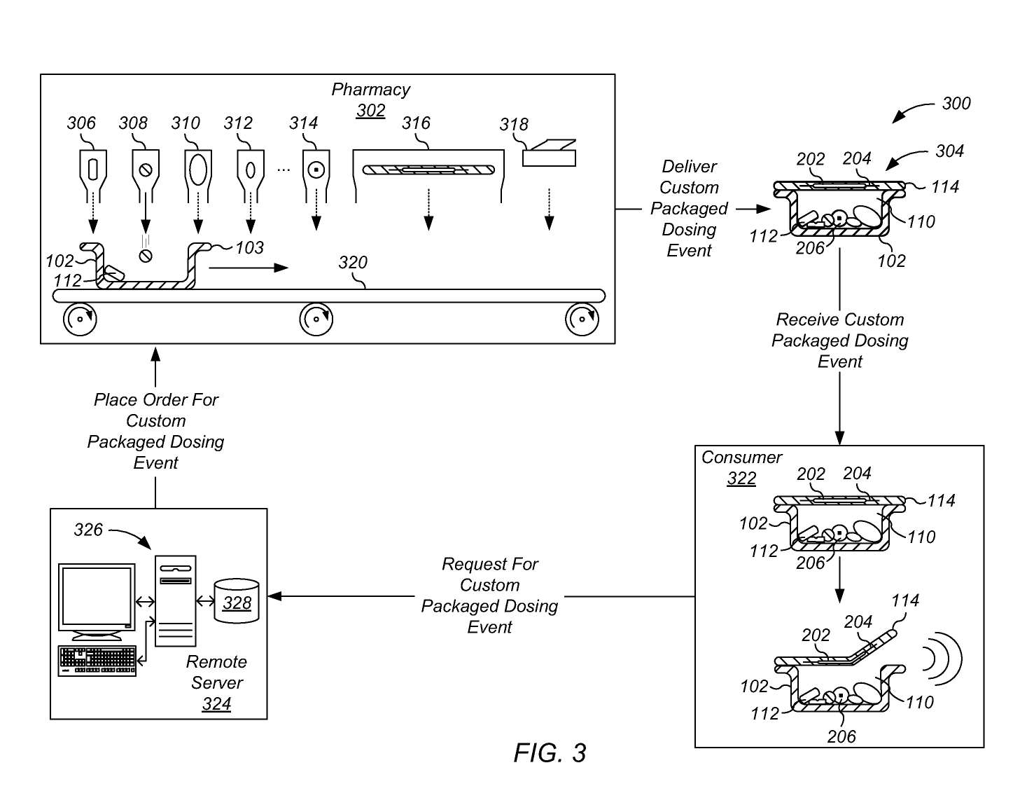

FIG. 3 illustrates one aspect of a system 300 for packaging and tracking a polypharmacy custom medication dosing unit. The system 300 shown in FIG. 3 comprises a pharmacy 302 (or physician's office, drug manufacturer, or nutrition center), a consumer 322, such as a patient for which the polypharmacy custom medication dosing unit package 304 is produced for, and a remote server computer 324 located at a remote node as described in connection with FIGS. 1 and 2. With reference back to FIG. 3, the consumer 322 places a request for custom packaged dosing unit package 304 to the remote server computer 324. The remote server computer 324 receives the request from the consumer 322 and transmits a request to the pharmacy 302 to place an order for the polypharmacy custom medication dosing unit package 304 in accordance with the consumer's 322 instructions. The pharmacy 302 fills the order and delivers the custom packaged dosing event package 304 to the consumer 322. Upon receiving the package 304 the consumer 322 takes the medication(s) 112 an/or the IEM device 206 contained in the package 304 in accordance with specific instructions from the physician or pharmacy. When the consumer opens the closure element 114, the circuit element 202 initiates a wireless transmission via the antenna 204 to a local node, as discussed in connection with FIGS. 1 and 2. The dosing event is communicated to the remote server computer 324 via one or more wired and/or wireless networks where the information associated with the consumer, the package 304, and the date and time stamp of the dosing event, among others, are received by the processing system 326 and stored in a database 328. The processing system 326 monitors all such dosing events from one or more consumers 322. The processing system 326 may automatically determine when to place an order for a new supply of polypharmacy custom medication dosing unit package 304 with the pharmacy 302.

It will be appreciated that the remote server computer 324 may be located at a physician's office, pharmacy, drug manufacturer, nutrition center, or other entity associated with the treatment and prescription of medication(s) 112 and IEM devices 206 to the consumer 322. In other aspects, the remote server computer 324 may be located in any location worldwide to serve the function of tracking the polypharmacy custom medication dosing unit package 304 consumed by the consumer 322, placing orders with the pharmacy 302, among other functions.

The polypharmacy custom medication dosing unit package 304 may be produced by the pharmacy 302 or drug manufacturer, physician, nutrition center, or other entity that is qualified to dispense the medication(s) 112 and/or the IEM device 206 contained in the package 304. Once the pharmacy 302 receives the order for the polypharmacy custom medication dosing unit package 304, the process of producing such a package 304 may proceed manually, automatically, or a combination of both. As shown, the shell element 103 of the package 102 moves along a computerized conveyer system 320 where the medications that comprise the polypharmacy custom medication dosing unit are dispensed into the shell element 103 from dispensers 306, 308, 310, 312, 314. Each of the dispensers 306, 308, 310, 312, 314 releasing a medication into the shell element 103 according to the order received from the remote server 324. Upon fulfilling the order for the polypharmacy custom medication dosing unit, a closure element comprising a circuit element 202 and antenna 204 is applied to the shell element 103 at station 316. A printer 318, or other marking mechanism, applies a custom marking on the exterior portion of the closure element to indicate, among other elements, the name of consumer 322, the medication(s) 112 content of the package 304, the IEM device 206 identification, a package 304 identification, date and time that package 304 was filled. Also, the circuit element 202 may be programmed with the information to transmit upon opening the closure element 114. Such information comprises information associated with the individual consumer (e.g., patient) and/or the medication(s) 112, the name of the consumer (e.g., patient), packaging date and time, dosing event (e.g., morning, evening, daily), contents of the package, expiration date, shelf life, type of IEM device 206 contained inside the package 304, for example.

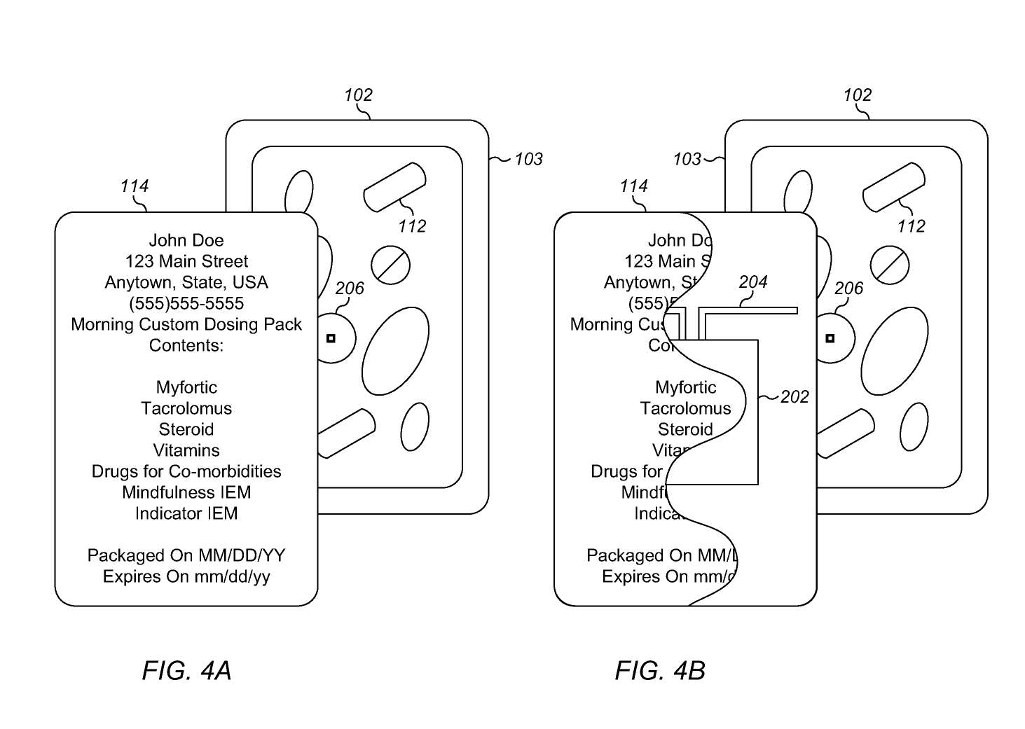

FIG. 4A illustrates one aspect of a single dosing unit customized package 102 for an individual patient where the single dosing unit comprising multiple medications 112. In the illustrated example, an IEM device 206 also is included in the package 114. The closure element 114 is shown partially removed from the shell element 103 for the purpose of showing the contents of the package 102. The exterior portion of the closure element 114 includes the custom printed markings include, without limitation, the name, address, and telephone number of the patient, the contents, the packaging date, and the expiration date.

FIG. 4B is a partial cutaway view of the multiple medication single dosing unit package 102 shown in FIG. 4A illustrating a circuit element 202 embedded in the closure element 114 portion of the housing of the multiple medication single dosing unit package 102. In one aspect, the circuit element 202 comprises a radio circuit and wirelessly transmits information via the antenna 204 when the closure element 114 is peeled off the shell element 103 of the housing. In one aspect, the information transmitted by the circuit element 202 is preprogrammed and may be the same or analogous to the information marked on the exterior portion of the closure element 114. Although not shown for clarity of disclosure, the multi-dose package 104 shown in FIG. 1, also comprises a similar circuit module 115 embedded in the individual closure element 118.

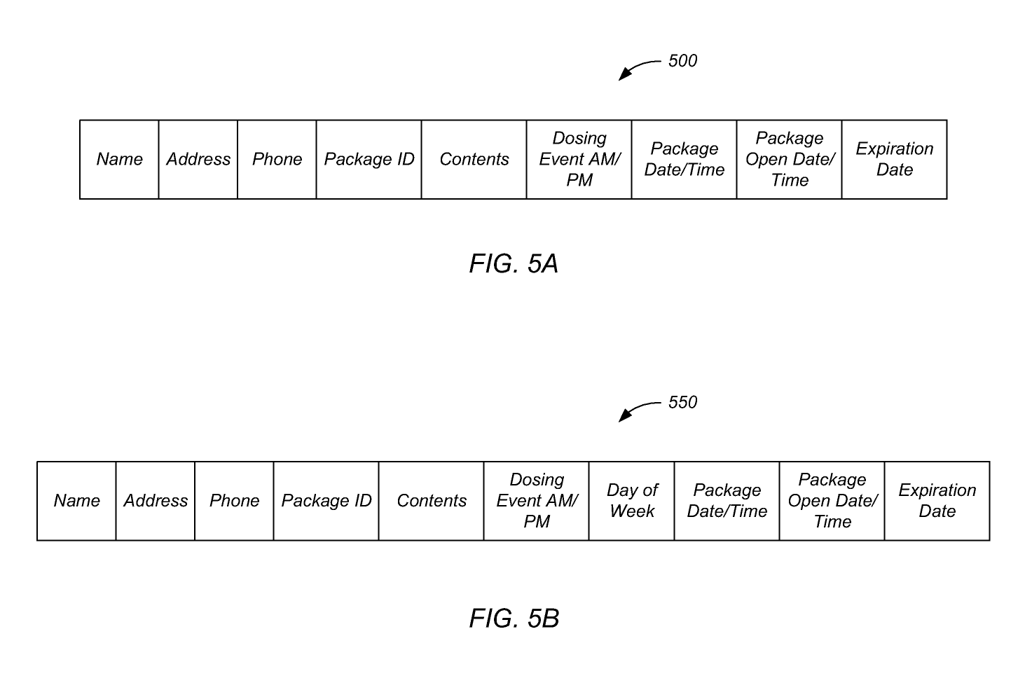

FIG. 5A is a diagram illustrating a typical packet 500 of information communicated from an individual patient customized single-dose package. In one aspect, the packet 500 includes the patient's name, address and telephone number, the package identification, the contents of the package including IEM device identification is applicable, the dosing event (e.g., AM/PM), the date and time when the package was sealed, the date and time when the package was opened, and the expiration date of the contents of the package.

FIG. 5B is a diagram illustrating a typical packet 550 of information communicated from an individual patient customized multi-dose package. In one aspect, the packet 550 includes the information included in the packet 500 shown in FIG. 5A and in addition includes the day of the week corresponding to the opened compartment from which the medication was taken.

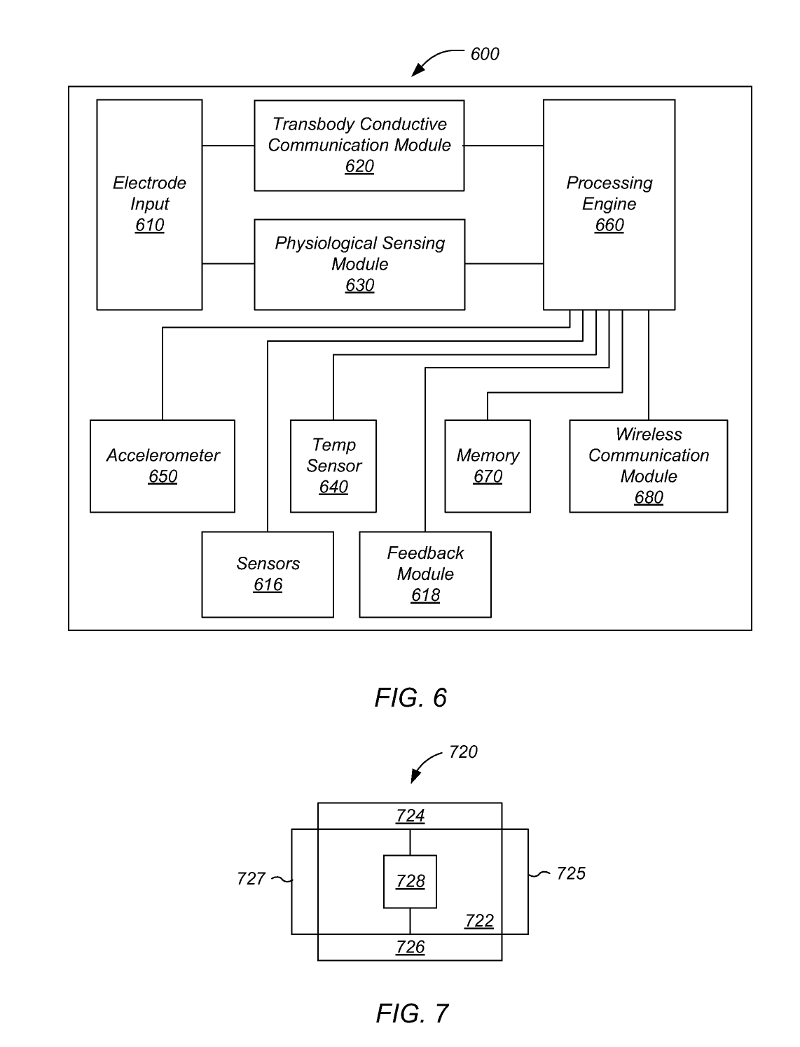

FIG. 6 is a block functional diagram of one aspect of an integrated circuit component of the patch 214 shown in FIG. 2. In FIG. 6, a patch 600 comprises an electrode input 610. Electrically coupled to the electrode input 610 are a transbody conductive communication module 620 and a physiological sensing module 630. In one aspect, the transbody conductive communication module 620 is implemented as a first, e.g., high, frequency (HF) signal chain and the physiological sensing module 630 is implemented as a second, e.g., low, frequency (LF) signal chain. Also shown are CMOS temperature sensing module 640 (for detecting ambient temperature) and a 3-axis accelerometer 650. The patch 600 also comprises a processing engine 660 (for example, a microcontroller and digital signal processor), a non-volatile memory 670 (for data storage), and a wireless communication module 680 (to receive data from and/or transmit data to another device, for example in a data download/upload action, respectively). In various aspects, the communication modules 620, 680 may comprise one or more transmitters/receivers (“transceiver”) modules. As used herein, the term “transceiver” may be used in a very general sense to include a transmitter, a receiver, or a combination of both, without limitation. In one aspect, the transbody conductive communication module 620 is configured to communicate with the IEM device 206-1 (FIG. 2). In one aspect, the wireless communication module 680 may be configured to communicate with the wireless access point 208 (FIG. 2). In another aspect, the wireless communication module 680 may be configured to communicate with the opened single-dose package 102-1 (FIG. 2), or multi-dose package, for example. In yet another aspect, the wireless communication module 680 may be configured to communicate with the mobile devices 216 (FIG. 2).

The sensors 616 typically contact the patient 212 (FIG. 2), e.g., are removably attached to the torso. In various aspects, the sensors 616 may be removably or permanently attached to the patch 600. For example, the sensors 616 may be removably connected to the patch 600 by snapping metal studs. The sensors 616 may comprise, for example, various devices capable of sensing or receiving the physiologic data. The types of sensors 616 include, for example, electrodes such as biocompatible electrodes. The sensors 616 may be configured, for example, as a pressure sensor, a motion sensor, an accelerometer, an electromyography (EMG) sensor, an IEM device 206 (FIG. 2), a biopotential sensor, an electrocardiogram sensor, a temperature sensor, a tactile event marker sensor, and an impedance sensor.

The feedback module 618 may be implemented with software, hardware, circuitry, various devices, and combinations thereof. The function of the feedback module 618 is to provide communication with the patient 212 (FIG. 2) in a discreet, tactful, circumspect manner as described above. In various aspects the feedback module 618 may be implemented to communicate with the patient 212 using techniques that employ visual, audio, vibratory/tactile, olfactory, and taste.

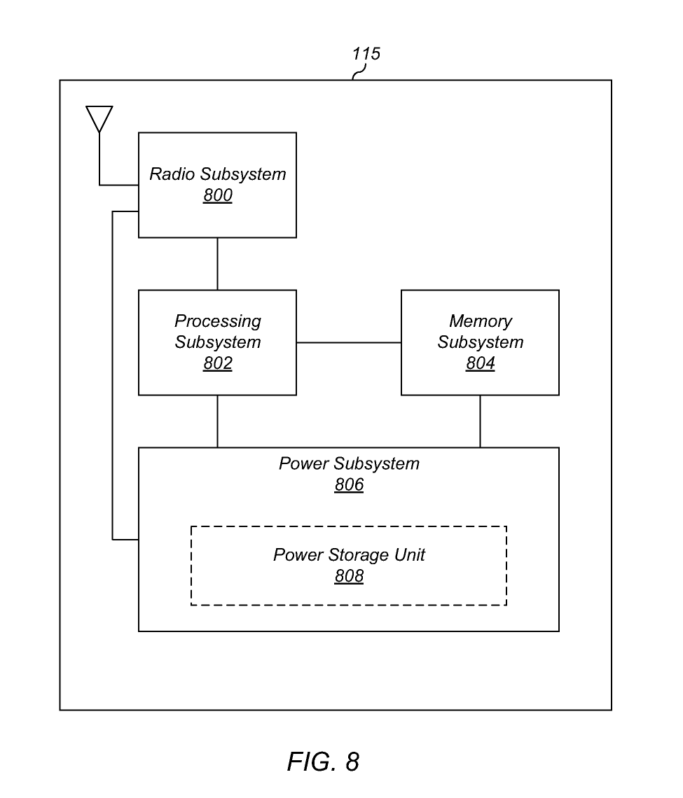

FIG. 7 shows one aspect of an ingestible event marker. In various aspects the IEM devices 130, 206 shown in FIGS. 1 and 2-4 may be implemented in accordance with the system 720 shown in FIG. 7. The system 720 can be used in association with any medication product, as mentioned above, to determine the origin of the medication and to confirm that at least one of the right type and the right dosage of medication was delivered to the patient and in some aspects to determine when a patient takes the medication product. The scope of the present disclosure, however, is not limited by the environment and the medication product that may be used with the system 720. For example, the system 720 may be activated either in wireless mode, in galvanic mode by placing the system 720 within a capsule and then placing the capsule within a conducting fluid, or a combination thereof, or exposing the system 720 to air. Once placed in a conducting fluid, for example, the capsule would dissolve over a period of time and release the system 720 into the conducting fluid. Thus, in one aspect, the capsule would contain the system 720 and no product. Such a capsule may then be used in any environment where a conducting fluid is present and with any product. For example, the capsule may be dropped into a container filled with jet fuel, salt water, tomato sauce, motor oil, or any similar product. Additionally, the capsule containing the system 720 may be ingested at the same time that any pharmaceutical product is ingested in order to record the occurrence of the event, such as when the product was taken.

In the specific example of the system 720 combined with a medication or pharmaceutical product, as the product or pill is ingested, or exposed to air, the system 720 is activated in galvanic mode. This may be particularly useful when a caregiver or user wants to know if the seal of the ingestible device has been broken on the single- or multi-dose packages 102, 104 (FIGS. 1-4), or if the ingestible device was exposed to air in certain climates, e.g., high humidity that may potentially degrade an ingestible device such as an IEM device 130 (FIG. 1), 206 (FIGS. 2-4). The system 720 controls conductance to produce a unique current signature that is detected by the patch 214 (FIG. 2), for example, thereby signifying that the pharmaceutical product has been taken. When activated in wireless mode, the system controls modulation of capacitive plates to produce a unique voltage signature associated with the system 720 that is detected.

In one aspect, the system 720 includes a framework 722. The framework 722 is a chassis for the system 720 and multiple components are attached to, deposited upon, or secured to the framework 722. In this aspect of the system 720, a digestible material 724 is physically associated with the framework 722. The material 724 may be chemically deposited on, evaporated onto, secured to, or built-up on the framework all of which may be referred to herein as “deposit” with respect to the framework 722. The material 724 is deposited on one side of the framework 722. The materials of interest that can be used as material 724 include, but are not limited to: Cu, CuCI, or Cul. The material 724 is deposited by physical vapor deposition, electrodeposition, or plasma deposition, among other protocols. The material 724 may be from about 0.05 to about 500 μm thick, such as from about 5 to about 100 μm thick. The shape is controlled by shadow mask deposition, or photolithography and etching. Additionally, even though only one region is shown for depositing the material, each system 720 may contain two or more electrically unique regions where the material 724 may be deposited, as desired.

At a different side, which is the opposite side as shown in FIG. 7, another digestible material 726 is deposited, such that the materials 724, 726 are dissimilar and insulated from each other. Although not shown, the different side selected may be the side next to the side selected for the material 724. The scope of the present disclosure is not limited by the side selected and the term “different side” can mean any of the multiple sides that are different from the first selected side. In various aspects, the dissimilar material may be located at different positions on a same side. Furthermore, although the shape of the system is shown as a square, the shape may be any geometrically suitable shape. The materials 724, 726 are selected such that they produce a voltage potential difference when the system 720 is in contact with conducting liquid, such as body fluids. The materials of interest for material 726 include, but are not limited to: Mg, Zn, or other electronegative metals. As indicated above with respect to the material 724, the material 726 may be chemically deposited on, evaporated onto, secured to, or built-up on the framework. Also, an adhesion layer may be necessary to help the material 726 (as well as material 724 when needed) to adhere to the framework 722. Typical adhesion layers for the material 726 are Ti, TiW, Cr or similar material. Anode material and the adhesion layer may be deposited by physical vapor deposition, electrodeposition or plasma deposition. The material 726 may be from about 0.05 to about 500 μm thick, such as from about 5 to about 100 μm thick. However, the scope of the present disclosure is not limited by the thickness of any of the materials nor by the type of process used to deposit or secure the materials to the framework 722.

According to the disclosure set forth, the materials 724, 726 can be any pair of materials with different electrochemical potentials. Additionally, in the embodiments wherein the system 720 is used in-vivo, the materials 724, 726 may be vitamins that can be absorbed. More specifically, the materials 724, 726 can be made of any two materials appropriate for the environment in which the system 720 will be operating. For example, when used with an ingestible product, the materials 724, 726 are any pair of materials with different electrochemical potentials that are ingestible. An illustrative example includes the instance when the system 720 is in contact with an ionic solution, such as stomach acids. Suitable materials are not restricted to metals, and in certain embodiments the paired materials are chosen from metals and non-metals, e.g., a pair made up of a metal (such as Mg) and a salt (such as CuCI or Cul). With respect to the active electrode materials, any pairing of substances—metals, salts, or intercalation compounds—with suitably different electrochemical potentials (voltage) and low interfacial resistance are suitable.

Materials and pairings of interest include, but are not limited to, those reported in TABLE 1 below. In one embodiment, one or both of the metals may be doped with a non-metal, e.g., to enhance the voltage potential created between the materials as they come into contact with a conducting liquid. Non-metals that may be used as doping agents in certain embodiments include, but are not limited to: sulfur, iodine, and the like. In another embodiment, the materials are copper iodine (Cul) as the anode and magnesium (Mg) as the cathode. Aspects of the present disclosure use electrode materials that are not harmful to the human body.

TABLE 1

| | Anode | Cathode |
|---|---|---|
| Metals | Magnesium, Zinc | |
| | Sodium, Lithium | |
| | Iron | |
| Salts | | Copper salts: iodide, chloride, bromide, |
| | | sulfate, formate, (other anions possible) |
| | | Fe³⁺ salts: e.g. orthophosphate, |
| | | pyrophosphate, (other anions possible) |
| | | Oxygen or Hydrogen ion (H+) on |
| | | platinum, gold or other catalytic |
| | | surfaces |
| Intercalation | Graphite with Li, | Vanadium oxide |
| compounds | K, Ca, Na, Mg | Manganese oxide |

Thus, when the system 720 is in contact with the conducting fluid, a current path is formed through the conducting fluid between the dissimilar materials 724, 726. A control device 728 is secured to the framework 722 and electrically coupled to the materials 724, 726. The control device 728 includes electronic circuitry, for example control logic that is capable of controlling and altering the conductance between the materials 724, 726.

The voltage potential created between the dissimilar materials 724, 726 provides the power for operating the system as well as produces the current flow through the conducting fluid and the system 720. In one aspect, the system 720 operates in direct current mode. In an alternative aspect, the system 720 controls the direction of the current so that the direction of current is reversed in a cyclic manner, similar to alternating current. As the system reaches the conducting fluid or the electrolyte, where the fluid or electrolyte component is provided by a physiological fluid, e.g., stomach acid, the path for current flow between the dissimilar materials 724, 726 is completed external to the system 720; the current path through the system 720 is controlled by the control device 728. Completion of the current path allows for the current to flow and in turn a receiver, not shown, can detect the presence of the current and recognize that the system 720 has been activate and the desired event is occurring or has occurred.

In one aspect, the two materials 724, 726 are similar in function to the two electrodes needed for a direct current power source, such as a battery. The conducting liquid acts as the electrolyte needed to complete the power source. The completed power source described is defined by the electrochemical reaction between the materials 724, 726 of the system 720 and enabled by the fluids of the body. The completed power source may be viewed as a power source that exploits electrochemical conduction in an ionic or a conducting solution such as gastric fluid, blood, or other bodily fluids and some tissues.

Additionally, the environment may be something other than a body and the liquid may be any conducting liquid. For example, the conducting fluid may be salt water or a metallic based paint.

In certain aspects, the two dissimilar materials 724, 726 are shielded from the surrounding environment by an additional layer of material. Accordingly, when the shield is dissolved and the two dissimilar materials 724, 726 are exposed to the target site, a voltage potential is generated.

In certain aspects, the complete power source or supply is one that is made up of active electrode materials, electrolytes, and inactive materials, such as current collectors, packaging. The active materials are any pair of materials with different electrochemical potentials. Suitable materials are not restricted to metals, and in certain embodiments the paired materials are chosen from metals and non-metals, e.g., a pair made up of a metal (such as Mg) and a salt (such as Cul). With respect to the active electrode materials, any pairing of substances—metals, salts, or intercalation compounds—with suitably different electrochemical potentials (voltage) and low interfacial resistance are suitable.

A variety of different materials may be employed as the materials that form the electrodes. In certain embodiments, electrode materials are chosen to provide for a voltage upon contact with the target physiological site, e.g., the stomach, sufficient to drive the system of the identifier. In certain embodiments, the voltage provided by the electrode materials upon contact of the metals of the power source with the target physiological site is 0.001 V or higher, including 0.01 V or higher, such as 0.1 V or higher, e.g., 0.3 V or higher, including 0.5 volts or higher, and including 1.0 volts or higher, where in certain embodiments, the voltage ranges from about 0.001 to about 10 volts, such as from about 0.01 to about 10 V.

Referring still to FIG. 7, the dissimilar materials 724, 726 provide the voltage potential to activate the control device 728. Once the control device 728 is activated or powered up, the control device 728 can alter conductance between the first and second materials 724, 726 in a unique manner. By altering the conductance between the first and second materials 724, 726, the control device 728 is capable of controlling the magnitude of the current through the conducting liquid that surrounds the system 720. This produces a unique current signature that can be detected and measured by a receiver (not shown), which can be positioned internal or external to the body. The receiver is disclosed in greater detail in U.S. patent application Ser. No. 12/673,326 entitled “BODY-ASSOCIATED RECEIVER AND METHOD” filed on Dec. 15, 2009, and published as 2010-0312188 A1 dated Dec. 9, 2010, which is incorporated herein by reference in its entirety. In addition to controlling the magnitude of the current path between the materials, non-conducting materials, membrane, or “skirt” are used to increase the “length” of the current path and, hence, act to boost the conductance path, as disclosed in the U.S. patent application Ser. No. 12/238,345 entitled, “IN-BODY DEVICE WITH VIRTUAL DIPOLE SIGNAL AMPLIFICATION” filed Sep. 25, 2008, and published as 2009-0082645 A1 dated Mar. 26, 2009 the entire content of which is incorporated herein by reference. Alternatively, throughout the disclosure herein, the terms “non-conducting material,” “membrane,” and “skirt” are interchangeably used with the term “current path extender” without impacting the scope or the present embodiments and the claims herein. The skirt, shown in portion at 725, 727, respectively, may be associated with, e.g., secured to, the framework 722. Various shapes and configurations for the skirt are contemplated as within the scope of the various aspects of the present invention. For example, the system 720 may be surrounded entirely or partially by the skirt and the skirt may be positioned along a central axis of the system 120 or off-center relative to a central axis. Thus, the scope of the present invention as claimed herein is not limited by the shape or size of the skirt. Furthermore, in other embodiments, the dissimilar materials 724, 726 may be separated by one skirt that is positioned in any defined region between the dissimilar materials 724, 726.

The system 720 may be grounded through a ground contact. The system 720 also may include a sensor module. In operation, ion or current paths are established between the first material 724 to the second material 726 and through a conducting fluid in contact with the system 720. The voltage potential created between the first and second materials 724, 726 is created through chemical reactions between the first and second materials 724, 726 and the conducting fluid. In one aspect, the surface of the first material 724 is not planar, but rather an irregular surface. The irregular surface increases the surface area of the material and, hence, the area that comes in contact with the conducting fluid.

In one aspect, at the surface of the first material 724, there is chemical reaction between the material 724 and the surrounding conducting fluid such that mass is released into the conducting fluid. The term mass as used herein refers to protons and neutrons that form a substance. One example includes the instant where the material is CuCl and when in contact with the conducting fluid, CuCl becomes Cu (solid) and Cl— in solution. The flow of ions into the conduction fluid is via ion paths. In a similar manner, there is a chemical reaction between the second material 726 and the surrounding conducting fluid and ions are captured by the second material 726. The release of ions at the first material 724 and capture of ion by the second material 726 is collectively referred to as the ionic exchange. The rate of ionic exchange and, hence the ionic emission rate or flow, is controlled by the control device 728. The control device 728 can increase or decrease the rate of ion flow by altering the conductance, which alters the impedance, between the first and second materials 724, 726. Through controlling the ion exchange, the system 720 can encode information in the ionic exchange process. Thus, the system 720 uses ionic emission to encode information in the ionic exchange.

The control device 728 can vary the duration of a fixed ionic exchange rate or current flow magnitude while keeping the rate or magnitude near constant, similar to when the frequency is modulated and the amplitude is constant. Also, the control device 728 can vary the level of the ionic exchange rate or the magnitude of the current flow while keeping the duration near constant. Thus, using various combinations of changes in duration and altering the rate or magnitude, the control device 728 encodes information in the current flow or the ionic exchange. For example, the control device 728 may use, but is not limited to any of the following techniques namely, Binary Phase-Shift Keying (PSK), Frequency Modulation (FM), Amplitude Modulation (AM), On-Off Keying, and PSK with On-Off Keying.

Various aspects of the system 720 may comprise electronic components as part of the control device 728. Components that may be present include but are not limited to: logic and/or memory elements, an integrated circuit, an inductor, a resistor, and sensors for measuring various parameters. Each component may be secured to the framework and/or to another component. The components on the surface of the support may be laid out in any convenient configuration. Where two or more components are present on the surface of the solid support, interconnects may be provided.

The system 720 controls the conductance between the dissimilar materials and, hence, the rate of ionic exchange or the current flow. Through altering the conductance in a specific manner the system is capable of encoding information in the ionic exchange and the current signature. The ionic exchange or the current signature is used to uniquely identify the specific system. Additionally, the system 720 is capable of producing various different unique exchanges or signatures and, thus, provides additional information. For example, a second current signature based on a second conductance alteration pattern may be used to provide additional information, which information may be related to the physical environment. To further illustrate, a first current signature may be a very low current state that maintains an oscillator on the chip and a second current signature may be a current state at least a factor of ten higher than the current state associated with the first current signature.

It is worthy to note that any reference to “one aspect” or “an aspect” means that a particular feature, structure, or characteristic described in connection with the aspect is included in at least one aspect. Thus, appearances of the phrases “in one aspect” or “in an aspect” in various places throughout the specification are not necessarily all referring to the same aspect. Furthermore, the particular features, structures or characteristics may be combined in any suitable manner in one or more aspects.

Some aspects may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other.

While certain features of the aspects have been illustrated as described herein, many modifications, substitutions, changes and equivalents will now occur to those skilled in the art. It is therefore to be understood that the appended claims are intended to cover all such modifications and changes as fall within the true spirit of the aspects.

1. A custom medication dosing unit, comprising:
a housing comprising at least one shell element provided with a bottom surface and a circumferential edge extending upwardly from the bottom surface and a portion defining an opening for accommodating at least one medication;
a first closure element provided with a circumferential edge placed on the circumferential edge of the shell element in an adhering and closing manner;
at least one medication disposed within the opening defined between the shell element and the first closure element; and
a circuit module associated within the first closure element.

2. The custom medication dosing unit of claim 1, wherein the circuit module comprises a circuit element and an antenna coupled to the circuit element, wherein the circuit element comprises a radio operative to wirelessly communicate information associated with the at least one medication with a local node.

3. The custom medication dosing unit of claim 1, wherein the circuit module comprises a power storage unit to receive power from an external source and store the power in the power storage unit.

4. The custom medication dosing unit of claim 2, wherein the circuit module comprises a memory with information associated with the at least one medication contained within the housing stored therein.

5. The custom medication dosing unit of claim 3, wherein the memory comprises information associated with the consumer of the at least one medication.

6. The custom medication dosing unit of claim 1, comprising a sensor to detect when the first closure element is removed from the shell element and to activate the circuit module when the first closure element is removed.

7. The custom medication dosing unit of claim 1, wherein the housing comprises multiple compartments, each defining a shell element provided with a bottom surface and an upright circumferential edge extending upwardly from the planar bottom surface and a portion defining an opening for accommodating at least one medication.

8. The custom medication dosing unit of claim 1, further comprising a storage compartment for accommodating therein an ingestible device and a second closure element for sealing the ingestible in the storage compartment.

9. The custom medication dosing unit of claim 8, wherein the ingestible device comprises any one of an ingestible event marker, and ingestible radio frequency identification (RFID) tag, an ingestible coil, and an ingestible magnet.

10. The custom medication dosing unit of claim 1, comprising a marking on an exterior portion of the closure element identifying the at least one medication contained within the housing.

11. A system for communicating a dosing event from a custom medication dosing unit, the system comprising:
a first custom medication dosing unit, the first custom medication dosing unit comprising:
a housing comprising at least one shell element provided with a bottom surface and a circumferential edge extending from the bottom surface and a portion defining an opening for accommodating at least one medication;
a first closure element provided with a circumferential edge placed on the circumferential edge of the shell element in an adhering and closing manner;
at least one medication disposed within the opening defined between the shell element and the first closure element; and
a circuit module associated within the first closure element, wherein the circuit module comprises a circuit element operative to wirelessly communicate information associated with the at least one medication with a local node.

12. The system of claim 11, wherein the local node comprises a local wireless access point and the circuit module is operative to communicate with the local wireless access point.

13. The system of claim 11, wherein the local node comprises a mobile device and the circuit module is operative to communicate with the mobile device.

14. The system of claim 11, wherein the local node comprises a patch and the circuit module is operative to communicate with the patch.

15. The system of claim 11, wherein the at least one medication comprises an ingestible device, and wherein the patch is operative to communicate with the first custom medication dosing unit when a consumer ingests the ingestible device.

16. The system of claim 11, wherein the local node comprises a second custom medication dosing unit, the second custom medication dosing unit comprising:
a housing comprising at least one shell element provided with a bottom surface and a circumferential edge extending upwardly from the bottom surface and a portion defining an opening for accommodating at least one medication;
a first closure element provided with a circumferential edge placed on the circumferential edge of the shell element in an adhering and closing manner;
at least one medication disposed within the opening defined between the shell element and the first closure element; and
a circuit module associated within the first closure element; and
wherein the first custom medication dosing unit is operative to communicate with the second custom medication dosing unit.

17. The system of claim 16, wherein the local node is operative to communicate with a remote node.

18. The system of claim 16, wherein the remote node comprises a processing system communicatively coupled to a database.

19. A method of manufacturing a custom medication dosing unit, the method comprising:
receiving an order for a custom medication dosing unit comprising at least one medication from a server.
dispensing the at least one medication into a housing comprising at least one shell element provided with a bottom surface and a circumferential edge extending from the bottom surface and a central portion defining an opening for accommodating the at least one medication; and
applying a closure element provided with a circumferential edge on the circumferential edge of the shell element in an adhering and closing manner, the closure element comprising a circuit module associated therewith.

20. The method of claim 19, comprising applying a marking on an exterior surface of the closure element by a printer device, wherein the marking is to identify the at least one medication.

21. The method of claim 19, comprising programming the circuit module with information associated with the at least one medication, wherein the information is to be transmitted upon opening the closure element.

22. The method of claim 19, comprising dispensing at least one ingestible device into the housing.

23. A custom medication dosing unit, comprising:
a housing;
a first compartment comprising:
at least a first shell element provided with a bottom surface and a circumferential edge extending upwardly from the bottom surface and a portion defining an opening for accommodating at least one medication;
a first closure element provided with a circumferential edge placed on the circumferential edge of the shell element in an adhering and closing manner; and
at least one ingestible device disposed within the opening defined between the shell element and the first closure element.

24. The custom medication dosing unit of claim 23, further comprising at least one medication disposed within the opening defined between the shell element and the first closure element.

25. The custom medication dosing unit of claim 23, further comprising:
a second compartment comprising:
at least a second shell element provided with a bottom surface and a circumferential edge extending upwardly from the bottom surface and a portion defining an opening for accommodating at least one medication; and
a second closure element provided with a circumferential edge placed on the circumferential edge of the shell element in an adhering and closing manner for sealing the medication in the second storage compartment; and
at least one medication disposed within the opening defined between the second shell element and the second closure element.

26. The custom medication dosing unit of claim 23, wherein the ingestible device comprises any one of an ingestible event marker, and ingestible radio frequency identification (RFID) tag, an ingestible coil, and an ingestible magnet.

27. The custom medication dosing unit of claim 25, wherein the housing comprises multiple first and second compartments, each defining a shell element provided with a bottom surface and an upright circumferential edge extending upwardly from the bottom surface and a portion defining an opening for accommodating at least one medication and at least one ingestible device.

28. The custom medication dosing unit of claim 24, comprising a marking on an exterior portion of the closure element identifying the at least one medication contained within the housing.

29. The custom medication dosing unit of claim 25, comprising a sensor to detect when either the first or second closure element is removed from the respective first or second shell element.

30. The custom medication dosing unit of claim 23, wherein the first closure element is pivotally coupled to the first shell element and the first closure element can be pivotally opened and closed.

31. The custom medication dosing unit of claim 25, wherein the second closure element comprises a peelable membrane for sealing the ingestible device within the second compartment.

32. The custom medication dosing unit of claim 23, wherein the first closure element comprises a blister membrane for sealing the ingestible device within the first compartment.

33. The custom medication dosing unit of claim 23, wherein the housing comprises information associated with any one of a name of a patient, a packaging date, a dosing event, and contents of either the first or second compartment.

34. The custom medication dosing unit of claim 23, wherein the housing comprises information that identifies the at least one medication contained inside the first compartment.

35. The custom medication dosing unit of claim 23, wherein the housing comprises information that identifies the at least one ingestible device contained inside the second compartment.

36. The custom medication dosing unit of claim 23, wherein the housing comprises markings indicating a day of the week on which either a medication or the ingestible device should be consumed.
